(19) United States
(12) Patent Application Publication
(10) Pub. No.: US 2008/0201516 A1
(43) Pub. Date: Aug. 21, 2008

(54) Input device, electronic device having input device, and input method thereof

(75) Inventor: Yen Liang Kuan, Taipei (TW)

Correspondence Address: BACON & THOMAS, PLLC, 625 SLATERS LANE, FOURTH FLOOR, ALEXANDRIA, VA, 22314, US

(73) Assignee: BEHAVIOR TECH COMPUTER CORP., Sijhih City (TW)

(21) Appl. No.: 12/071,205

(22) Filed: Feb. 19, 2008

(30) Foreign Application Priority Data
Feb. 16, 2007 (TW) 096106316

(51) Int. Cl. G06F 13/00

(52) U.S. Cl. 710/316

(57) ABSTRACT

An input devices includes a switch unit for selecting one of a plurality of application modes, the switch unit outputting a first signal in response to a selection made by a user with respect to the application mode; at least one hotkey, each hotkey outputting a second signal in response to an activation of hotkey by the user; and a control unit for outputting a third signal in response to the first signal and the second signal to enable execution of the actuated hotkey under the selected application mode.

### FIELD OF THE INVENTION

This invention relates to the input devices, electronic devices having the input devices, and input methods thereof.

### BACKGROUND OF THE INVENTION

In today's popular electronic devices, e.g. computers, mobile phones, PDAs, and the like, the functions that are more frequently used among various functions of the devices are usually implemented by proprietary buttons, i.e., hotkeys. Therefore, the design of the conventional hotkeys has been known in the related arts.

On the other hand, since the advent of the miniaturization technology, the electronic devices become small-sized and light-weighted. The amounts of functions of the electronic products are increasing while at the same time the size or weight of the electronic product is decreasing. Having more functions might require more hotkeys, but more hotkeys might contradict the down-sizing of the electronic product.

Accordingly, there is a need for an input device to electronic devices that provide more functions while decreasing the amount of hotkeys, so as to fulfill the objectives of small-size and light-weight of the electronic devices.

### SUMMARY OF THE INVENTION

The objectives of the present invention are to provide an input device to electronic devices that provide more functions with fewer amounts of hotkeys, an electronic device having the input device, and an input method.

In accordance with one aspect of the invention, there is provided an input device which includes a switch unit for selecting one of a plurality of application modes, the switch unit outputting a first signal in response to a selection made by a user with respect to the application mode; at least one hotkey, each hotkey outputting a second signal in response to an activation of hotkey by the user; and a control unit for outputting a third signal in response to the first signal and the second signal to enable execution of the actuated hotkey under the selected application mode. In an exemplary embodiment, the input device further including a display unit in response to a fourth signal outputted by the control unit for displaying one of text, graphic, and symbol that represent utility program, procedure, or control code to which each hotkey currently corresponds. In another exemplary embodiment, the display unit displays different application modes by using different colors. In another exemplary embodiment, the switch unit displays one of text, graphic, and symbol that represent utility program, procedure, or control code to which each hotkey currently corresponds. In another exemplary embodiment, at least one hotkey forms a hotkey set. In another exemplary embodiment, the input device is one of computer keyboard, cellular phone keyboard, elevator operation panel, and vending machine button panel. In another exemplary embodiment, the application modes comprise Internet mode, game mode, and data-processing mode.

In accordance with another aspect of the invention, there is provided an electronic device having the input device, the input device includes a switch unit for selecting one of a plurality of application modes, the switch unit outputting a first signal in response to a selection made by a user with respect to the application mode; at least one hotkey, each hotkey outputting a second signal in response to an activation of hotkey by the user; and a control unit for outputting a third signal in response to the first signal and the second signal to enable execution of the actuated hotkey under the selected application mode. In an exemplary embodiment, the input device further including a display unit in response to a fourth signal outputted by the control unit for displaying one of text, graphic, and symbol that represent utility program, procedure, or control code to which each hotkey currently corresponds. In another exemplary embodiment, the display unit displays different application modes by using different colors. In another exemplary embodiment, at least one hotkey forms a hotkey set. In another exemplary embodiment, the input device is one of computer keyboard, cellular phone keyboard, elevator operation panel, and vending machine button panel. In another exemplary embodiment, the application modes comprise Internet mode, game mode, and data-processing mode.

In accordance with another aspect of the invention, there is provided an input method for use in an input device, the input device comprising a switch unit, at least one hotkey, and a control unit, comprising the steps of: switching the switch unit to select an application mode for transmitting a first signal to the control unit; activating a hotkey to transmit a second signal to the control unit; and enabling execution of the activated hotkey under the selected application mode by a third signal, responsive to the first and the second signals. In an exemplary embodiment, the input device further including a display unit in response to a fourth signal outputted by the control unit for displaying one of text, graphic, and symbol that represent utility program, procedure, or control code to which each hotkey currently corresponds. In another exemplary embodiment, the display unit displays different application modes by using different colors. In another exemplary embodiment, the switch unit displays one of text, graphic, and symbol that represent utility program, procedure, or control code to which each hotkey currently corresponds. In another exemplary embodiment, at least one hotkey forms a hotkey set. In another exemplary embodiment, the input device is one of computer keyboard, cellular phone keyboard, elevator operation panel, and vending machine button panel. In another exemplary embodiment, the application modes comprise Internet mode, game mode, and data-processing mode.

### BRIEF DESCRIPTION OF DRAWINGS

The foregoing and advantages of the invention will be appreciated more fully from the following further description thereof with reference to the accompanying drawings wherein:

FIG. 1 shows an input device of an exemplary embodiment of the present invention.

FIG. 2 shows an input device of another exemplary embodiment of the present invention.

FIG. 3 shows a hotkey set of an exemplary embodiment of the present invention.

FIG. 4 shows a flow chart of an input method of an exemplary embodiment of the present invention.

FIG. 5 shows a flow chart of an input method of another exemplary embodiment of the present invention.

FIG. 6 shows an electronic device of an exemplary embodiment of the present invention.

FIG. 7 shows an electronic device of another exemplary embodiment of the present invention.

FIG. 8 shows a cross-section view of an input device of an exemplary embodiment of the present invention.

FIGS. 9A, 9B, and 9C are top views of the input device shown in FIG. 8 when switching to data-processing mode, Internet mode and game mode, respectively.

### DETAILED DESCRIPTION OF SPECIFIC EMBODIMENTS

The following exemplary examples will be described in detail with the appended drawings in order to make the aforementioned objectives, functional features, and advantages more clearly understood.

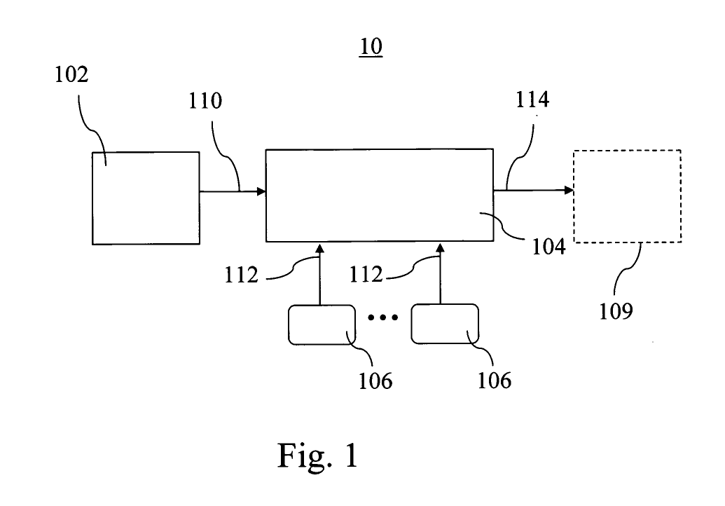

FIG. 1 shows an input device of an exemplary embodiment of the present invention. As shown in FIG. 1, input device 10 includes a switch unit 102, at least one hotkey 106, and a control unit 104. The switch unit 102 is used to select one of a plurality of application modes of the corresponding electronic device and output a first signal 110 in response to a selection made by a user with respect to the application modes. Each hotkey 106 is used to output a second signal 112 in response to an activation of hotkey by the user. The control unit 104 is used to output a third signal 114 in response to the first signal 110 and the second signal 112 to enable execution of the function corresponding to the actuated hotkey under the selected application mode. The execution of the function occurs in a processing unit 109. These application modes include, but not limited to, Internet mode, game mode, data-processing mode and so on. One of the most popular data-processing applications is the Microsoft® Office.

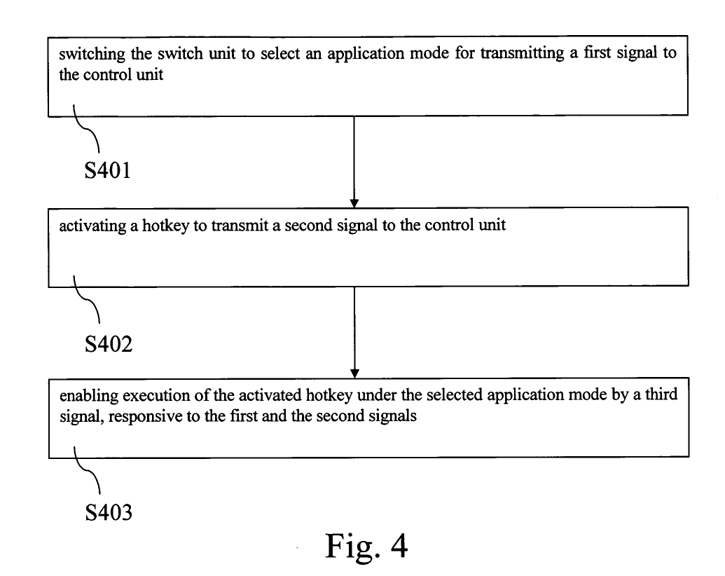

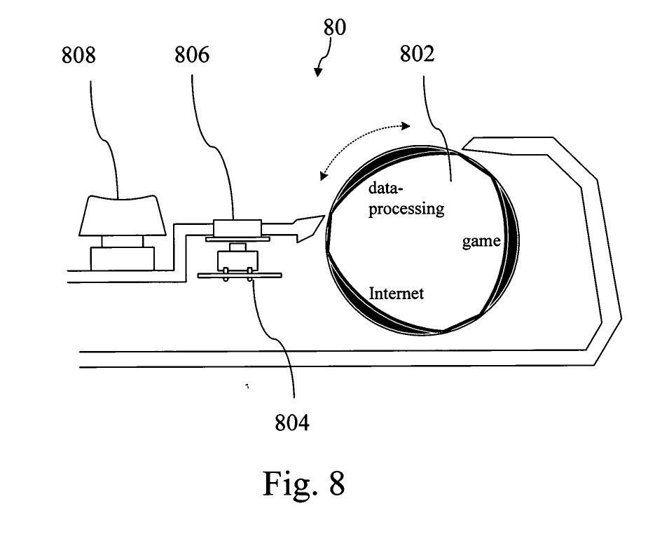

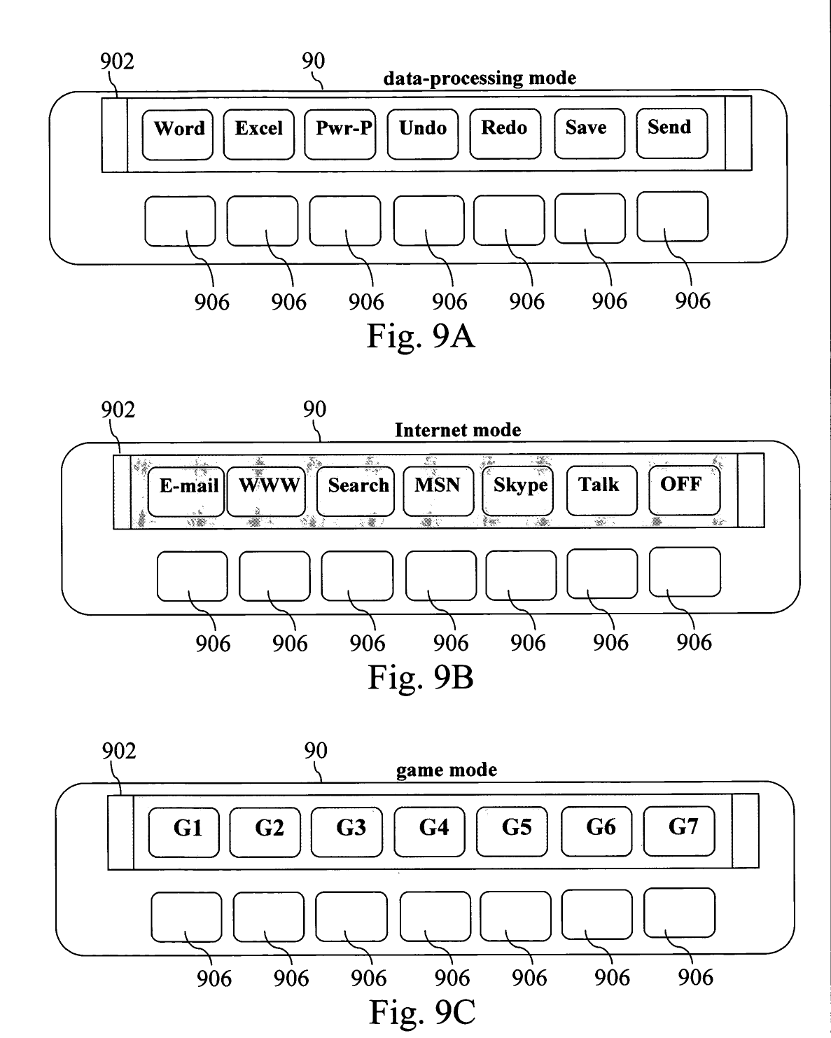

Referring to FIG. 4 with facilities of FIG. 1, FIG. 4 shows a flow chart of an input method of an exemplary embodiment of the present invention. In step S401, a switch unit 102 is switched to select an application mode for transmitting a first signal 110 to the control unit 104. More specifically, a user switches a switch unit 102 to select an application mode, and the switch unit 102 transmits a first signal 110 to the control unit 104. In step S402, a hotkey 106 is activated to transmit a second signal 112 to the control unit 104. More specifically, a user activates a hotkey 106, and the hotkey 106 transmits a second signal 112 to the control unit 104. In step S403, execution of the function corresponding to the activated hotkey 106 is enabled under the selected application mode triggered by a third signal 114, responsive to the first and the second signals 110 and 112. More specifically, when the control unit 104 receives the first signal 110 and the second signal 112, the control unit 104 outputs a third signal 114. The third signal 114 enables the execution of the function corresponding to the activated hotkey 106 under the selected application mode. In other words, the user firstly selects an application mode by switching the switch unit 102. Then, the user activates one hotkey 106. The control unit 104 outputs a third signal 114 to a processing unit 109 to start the utility program, procedure, or control code to which the hotkey 106 currently corresponds under the selected application mode. In an exemplary embodiment, the switch unit 102 is a roller-type switch unit which switches between the application modes by rotation of the switch unit. FIG. 8 shows a cross-section view of an input device with a roller-type switch unit of an exemplary embodiment of the present invention, in which a hotkey 806 and a general-purpose key 808 are shown. The switch unit 802 is divided into three parts corresponding to Internet mode, game mode, and data-processing mode respectively. In FIG. 8, the switch unit 802 is currently switched to the data-processing mode. In response, the switch unit 802 outputs a signal to a control unit (not shown in FIG. 8) setting the current mode of the hotkey 806 operating in the data-processing mode (as shown in FIG. 9A). When a hotkey 806 is pressed (activated), a sensor 804 senses the action and the control unit outputs a signal to a processing unit (not shown in FIG. 8) to start the utility program, procedure, or control code to which the pressed hotkey 806 currently corresponds under the data-processing mode. In an exemplary embodiment, the switch unit 802 displays either text, graphic or symbol that represent the utility program, procedure, or control code to which each hotkey currently corresponds. For example, a tag marking either the text, graphic or symbol that represent the utility program, procedure, or control code to which each hotkey currently corresponds is attached to or printed on the switch unit 802 in different colors or same colors, as shown in FIGS. 9A, 9B, and 9C. FIGS. 9A, 9B, and 9C are respectively top views of the input device shown in FIG. 8 when switching to the data-processing mode, Internet mode, and game mode respectively. In input device shown in FIGS. 9A, 9B and 9C, the input device 90 has seven hotkeys 906 and the switch unit 902 can select one of three modes, and therefore, twenty-one functions, i.e., the applications, procedures, or control codes, are provided by the input device. In an exemplary embodiment, the input device 10 may be either the computer keyboard, cellular phone keyboard, elevator operation panel or the vending machine button panel. Note that the core concept of the invention is to select the requisite application mode by switching a switch unit. Therefore, any other alternative elements that can achieve the objective can be used as the switch unit of the present invention. For example, an independent one-on-one switch controlling one specific mode, or a multiplex switch controlling a plurality of modes respectively, or the like might perform the switching function recited above. Therefore, by using the input device 10 of the present invention, the amounts of functionality of the input device 10 increase without substantial increase of the amounts of hotkeys of the input device 10.

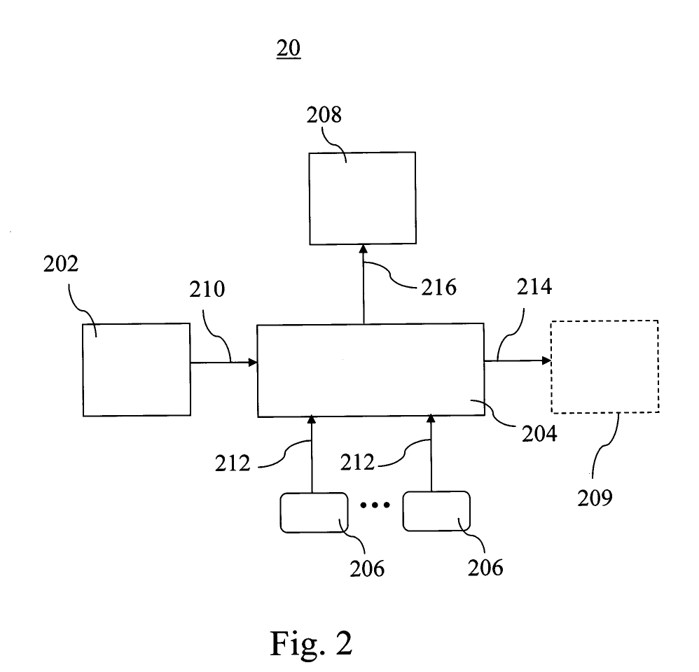

FIG. 2 shows an input device of another exemplary embodiment of the present invention. As shown in FIG. 2, input device 20 includes a switch unit 202, at least one hotkey 206, a control unit 204, and a display unit 208. The switch unit 102 is used to select one of a plurality of application modes of the corresponding electronic device and output a first signal 210 in response to a selection made by a user with respect to the application modes. Each hotkey 206 is used to output a second signal 212 in response to an activation of hotkey by the user. The control unit 204 is used to output a third signal 214 in response to the first signal 210 and the second signal 212 to enable execution of the function corresponding to the actuated hotkey under the selected application mode. The display unit 208 in response to a fourth signal 216 outputted by the control unit 204 displays either text, graphic or symbol that represent the utility program, procedure, or control code to which each hotkey currently corresponds. This exemplary embodiment is different from the above-mentioned one in that: this exemplary embodiment displays the utility program, procedure, or control code to which each hotkey currently corresponds by a display unit 208 rather than the tag. In an exemplary embodiment, the display unit 208 displays different application modes in different colors. The different utility programs, procedures, or control codes under one application mode are displayed in the same color for users to easily identify. In an exemplary embodiment, the input device 20 may be either the computer keyboard, cellular phone keyboard, elevator operation panel, and vending machine button panel. These application modes include, but not limited to, Internet mode, game mode, data-processing mode, and so on. Note that the core concept of the invention is to select the required application mode by switching a switch unit. Therefore, any other alternative elements that can achieve the objective can be used as the switch unit of the present invention. For example, an independent one-on-one switch controlling one specific mode, or a multiplex switch controlling a plurality of modes respectively, or the like might perform the switching function recited above. Therefore, by using the input device 20 of the present invention, the amounts of functionality of the input device 20 increase without substantial increase of the amounts of hotkeys of the input device 20.

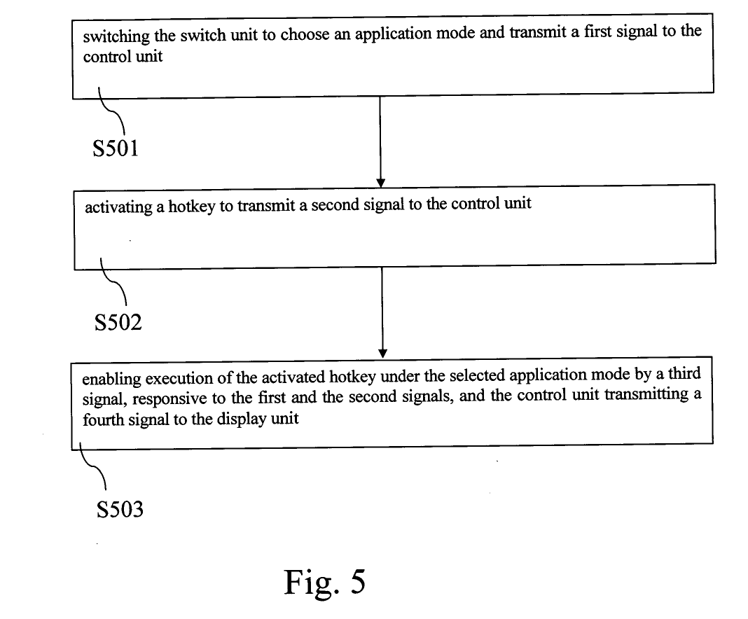

Referring to FIG. 5 with facilities of FIG. 2, FIG. 5 shows a flow chart of an input method of an exemplary embodiment of the present invention. In step S501, a switch unit 202 is switched to select an application mode for transmitting a first signal 210 to the control unit 204. More specifically, a user switches a switch unit 202 to select an application mode, and the switch unit 202 transmits a first signal 210 to the control unit 204. In step S502, a hotkey 206 is activated to transmit a second signal 212 to the control unit 204. More specifically, a user activates a hotkey 206, and the hotkey 206 transmits a second signal 212 to the control unit 204. In step S503, execution of the function corresponding to the activated hotkey 206 is enabled under the selected application mode triggered by a third signal 214, responsive to the first and the second signals 210 and 212, and the control unit 204 transmits a fourth signal 216 to a display unit 208. More specifically, when the control unit 204 receives the first signal 210 and the second signal 212, the control unit 204 outputs a third signal 214 and transmits a fourth signal 216 to a display unit 208. The third signal 214 enables the execution of the function corresponding to the activated hotkey 206 under the selected application mode. In other words, the user firstly selects an application mode by switching the switch unit 202. Then, the user activates one hotkey 206. The control unit 204 outputs a third signal 214 to a processing unit 209 to start the utility program, procedure, or control code to which the hotkey 206 currently corresponds under the selected application mode, and transmits a fourth signal 216 to a display 208 for displaying either text, graphic or symbol that represent the utility program, procedure, or control code to which each hotkey currently corresponds. Therefore, by using the input method of the present invention, the amounts of functionality of the input device increase without the increase of the amounts of hotkeys of the input device. Also, by the visual information displayed by the display unit 208, the utility program, procedure or control code to which each hotkey currently corresponds can be clearly identified.

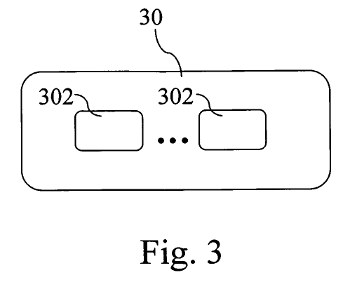

FIG. 3 shows a hotkey set of an exemplary embodiment of the present invention. As shown in FIG. 3, the hotkey set 30 includes a plurality of hotkeys 302. More specifically, the amount of hotkeys 302 in the hotkey set 30 can be configured depending on the actual requirements of the electronic devices. In an exemplary embodiment, the input device includes at least one hotkey set 30.

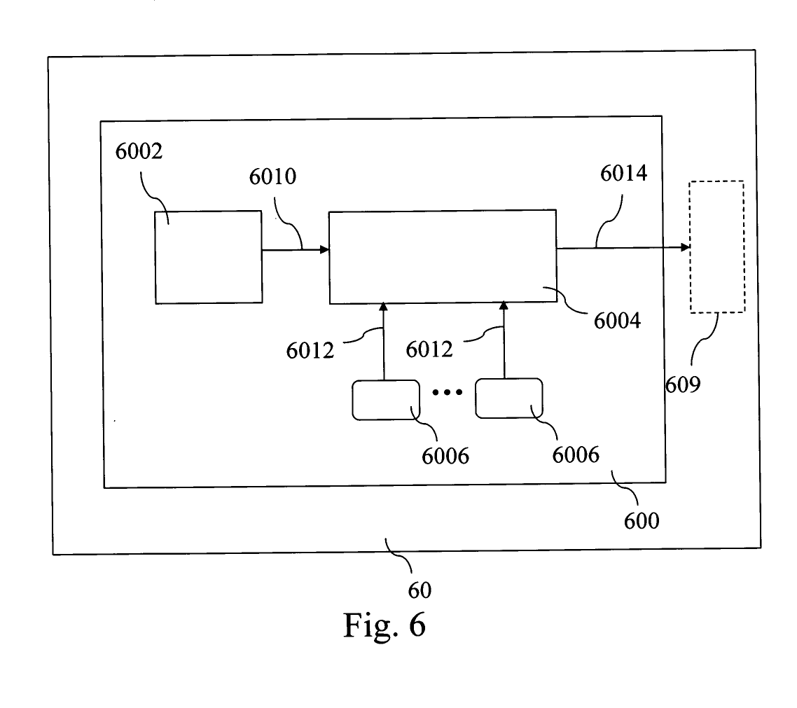

FIG. 6 shows an electronic device of an exemplary embodiment of the present invention. The electronic device 60 includes an input device 600 which may be in form of those input devices reiterated above when FIGS. 1, 2, 3, 8 and 9 are introduced. The input device 600 includes a switch unit 6002, at least one hotkey 6006, and a control unit 6004. The switch unit 6002 is used to select one of a plurality of application modes and output a first signal 6010 in response to a selection made by a user with respect to the application modes. Each hotkey 6006 is used to output a second signal 6012 in response to an activation of hotkey by the user. Among other matters, the control unit 6004 is used to output a third signal 6014 in response to the first signal 6010 and the second signal 6012 to enable execution of the function corresponding to the actuated hotkey under the selected application mode. The execution of the function occurs in a processing unit 609. Since the input device 600 may be implemented by the input device 10 or the like, the detailed description thereof is omitted.

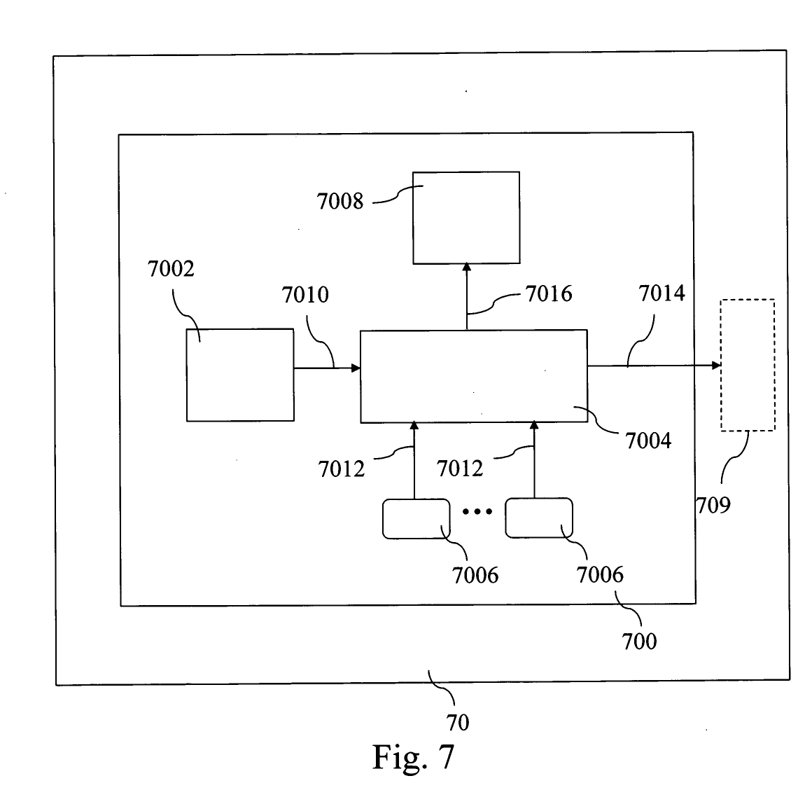

FIG. 7 shows an electronic device of another exemplary embodiment of the present invention. As shown in FIG. 7, the electronic device 70 includes an input device 700 which may be in form of those input devices reiterated above when FIGS. 1, 2, 3, 8 and 9 are introduced. The input device 700 includes a switch unit 7002, at least one hotkey 7006, a control unit 7004, and a display unit 7008. The switch unit 7002 is used to select one of a plurality of application modes and output a first signal 7010 in response to a selection made by a user with respect to the application modes. Each hotkey 7006 is used to output a second signal 7012 in response to an activation of hotkey by the user. Among other tasks, the control unit 7004 is used to output a third signal 7014 in response to the first signal 7010 and the second signal 7012 to enable execution of the function corresponding to the actuated hotkey under the selected application mode. The execution of the function occurs in a processing unit 709. The display unit 7008 in response to a fourth signal 7016 outputted by the control unit 7004 displays either the text, graphic, and symbol that represent the utility program, procedure, or control code to which each hotkey currently corresponds. Since the input device 700 may be implemented by the input device 20 or the like, the detailed description thereof is omitted.

In conclusion, the input devices, input methods, and electronic devices of the present invention have at least the following advantages: (1) under the limitation of hotkey region, more functions are provided; (2) different application modes are displayed in different colors. The different utility programs, procedures, or control codes under one application mode are displayed in the same color for users to easily identify; (3) only one hotkey set of a plurality of hotkey sets is enabled at one certain moment; (4) the area occupied by the hotkey sets is minimized. Therefore, the present invention has industrial applicability.

While various exemplary embodiments of the present invention are described herein, it should be noted that the present invention may be embodied in other specific forms, including various modifications and improvements, without departing from the spirit and scope of the present invention. Thus, the described embodiments are to be considered in all respects only as illustrative and not restrictive.

What is claimed is:

1. An input device, comprising:
a switch unit for selecting one of a plurality of application modes, the switch unit outputting a first signal in response to a selection made by a user with respect to the application mode;
at least one hotkey, each hotkey outputting a second signal in response to an activation of hotkey by the user; and
a control unit for outputting a third signal in response to the first signal and the second signal to enable execution of the actuated hotkey under the selected application mode.

2. The input device according to claim 1, further comprising a display unit in response to a fourth signal outputted by the control unit for displaying one of text, graphic, and symbol that represent utility program, procedure, or control code to which each hotkey currently corresponds.

3. The input device according to claim 2, wherein the display unit displays different application modes by using different colors.

4. The input device according to claim 1, wherein the switch unit displays one of text, graphic, and symbol that represent utility program, procedure, or control code to which each hotkey currently corresponds.

5. The input device according to claim 1, wherein at least one hotkey forms a hotkey set.

6. The input device according to claim 1, wherein the input device is one of computer keyboard, cellular phone keyboard, elevator operation panel, and vending machine button panel.

7. The input device according to claim 1, wherein the application modes comprise Internet mode, game mode, and data-processing mode.

8. An input method for use in an input device, the input device comprising a switch unit, at least one hotkey, and a control unit, comprising the steps of:
switching the switch unit to select an application mode for transmitting a first signal to the control unit;
activating a hotkey to transmit a second signal to the control unit; and
enabling execution of the activated hotkey under the selected application mode by a third signal, responsive to the first and the second signals.

9. The input method according to claim 8, wherein the input device further comprising a display unit, the method further comprising: the control unit transmitting a fourth signal to the display unit.

10. The input method according to claim 9, wherein the display unit displays different application modes by using different colors.

11. The input method according to claim 8, wherein at least one hotkey forms a hotkey set.

12. The input method according to claim 8, wherein the input device is one of computer keyboard, cellular phone keyboard, elevator operation panel, and vending machine button panel.

13. The input method according to claim 8, wherein the application modes comprises Internet mode, game mode, and data-processing mode.

14. An electronic device having an input device, the input device comprising:
a switch unit for selecting one of a plurality of application modes, the switch unit outputting a first signal in response to a selection made by a user with respect to the application mode;
at least one hotkey, each hotkey outputting a second signal in response to an activation of hotkey by the user; and
a control unit for outputting a third signal in response to the first signal and the second signal to enable execution of the actuated hotkey under the selected application mode.

15. The electronic device according to claim 14, wherein the input device further comprising a display unit in response to a fourth signal outputted by the control unit for displaying one of text, graphic, and symbol that represent utility program, procedure, or control code to which each hotkey currently corresponds.

16. The electronic device according to claim 15, wherein the display unit displays different application modes by using different colors.

17. The electronic device according to claim 14, wherein the switch unit displays one of text, graphic, and symbol that represent utility program, procedure, or control code to which each hotkey currently corresponds.

18. The electronic device according to claim 14, wherein at least one hotkey forms a hotkey set.

19. The electronic device according to claim 14, wherein the input device is one of computer keyboard, cellular phone keyboard, elevator operation panel, and vending machine button panel.

20. The electronic device according to claim 14, wherein the application modes comprise Internet mode, game mode, and data-processing mode.
